(19) United States
(12) Patent Application Publication
(10) Pub. No.: US 2002/0106046 A1
(43) Pub. Date: Aug. 8, 2002

(54) Radioisotope generating apparatus

(75) Inventors: Masatoshi Fujimoto, Hamamatsu-shi (JP); Shinichiro Aoshima, Hamamatsu-shi (JP); Makoto Hosoda, Hamamatsu-shi (JP); Yutaka Tsuchiya, Hamamatsu-shi (JP)

Correspondence Address: MORGAN LEWIS & BOCKIUS LLP, 1111 PENNSYLVANIA AVENUE NW, WASHINGTON, DC, 20004, US

(73) Assignee: HAMAMATSU PHOTONICS K.K.

(21) Appl. No.: 10/076,273

(22) Filed: Feb. 19, 2002

Related U.S. Application Data
(63) Continuation-in-part of application No. PCT/JP00/05550, filed on Aug. 18, 2000.

(30) Foreign Application Priority Data
Aug. 20, 1999 (JP) P1999-234169

(51) Int. Cl. G21G 1/00

(52) U.S. Cl. 376/156

(57) ABSTRACT

A radioisotope generating apparatus according to the present invention comprises a nuclear reaction section an interior of which is retained in a vacuum; a source supply section for supplying a source material R consisting of a nuclide necessary for generation of the radioisotope, to the nuclear reaction section, an optical system for emitting pulse laser light toward the source material R supplied into the nuclear reaction section and thereby brought into a dispersed state, thereby inducing a nuclear reaction in the source material R to generate the radioisotope, a product nucleus collecting section for collecting a molecule P_{I} having a nucleus of the radioisotope generated in the nuclear reaction section, and a radiation shielding system for preventing outside leakage of radiations generated in the nuclear reaction section. This permits the position of a reaction field of the nuclear reaction to be fixed in a specific small region inside the nuclear reaction section, whereby the space necessary for the nuclear reaction section can be largely decreased.

### RELATED APPLICATION

This is a continuation-in-part application of application serial no. PCT/JP00/05550 filed on Aug. 18, 2000, now pending.

### BACKGROUND OF THE INVENTION

1. Field of the Invention

The present invention relates to apparatus for generating a radioisotope.

2. Related Background Art

The radioisotopes are utilized as radiation sources and tracers in various fields. Particularly, artificial radioisotopes are expected to be used as medical tracers in positron CT (PET) and others.

The radioisotopes used as medical tracers are selected from those with relatively short life in consideration of effects on organisms and, for example, biological constituent elements such as ¹¹C, ¹³N, and ¹⁵O, and ¹⁸F are used in practice. These radioisotopes are able to be produced by accelerators, nuclear reactors, and laser nuclear fusion systems and, for example, the radioisotopes for PET are mainly produced by cyclotron accelerators.

However, since the conventional radioisotope generators as described above had large instrumental scale, they required a large space at an installation site and thus posed the problem that they were unable to be installed so as to suit facilities utilizing the generated radioisotopes. Namely, it was difficult to install a generator in a limited space in medical facilities and the like and permit free use at necessary occasions. Reasons for it are that these generators require a large space for the reactor in terms of the principle and that large shielding facilities are necessary for radiations generated from the whole of the large reactor.

In particular, on the occasion of generating and utilizing a radioisotope with relatively short life, the radioisotope should be ideally used at the same time as the generation thereof. Accordingly, the radioisotope cannot be effectively utilized unless the generator is directly coupled to the utilizing facilities because of its large scale. Even if the generator can be directly coupled to the utilizing facilities, the reactor occupying the large space will make it difficult to collect the generated radioisotope quickly and utilize it efficiently.

Further, since these generators had the large scale and were normally operated under continuous operating conditions, they involved the problem of increase in construction cost, cost necessary for maintenance, and needless running cost.

### SUMMARY OF THE INVENTION

It is an object of the present invention, which has been accomplished in view of the above problems, to provide compact, low-cost radioisotope generating apparatus that can be installed on-site at the utilizing facilities.

A radioisotope generating apparatus according to the present invention comprises a nuclear reaction section an interior of which is retained in a vacuum; a source supply section for supplying a source material consisting of a nuclide necessary for generation of a radioisotope, to the nuclear reaction section; an optical system for irradiating the source material supplied into the nuclear reaction section and thereby brought into a dispersed state, with pulse laser light, thereby inducing a nuclear reaction in the source material to generate the radioisotope; a product nucleus collecting section for collecting a molecule having a nucleus of the radioisotope generated in the nuclear reaction section; and a radiation shielding system for preventing outside leakage of radiations generated in the nuclear reaction section.

According to the present invention, the reaction field where the source material supplied from the source supply section experiences the desired nuclear reaction is formed in a small irradiated region with the pulse laser light of high peak power emitted from the optical system. In addition, this reaction field is fixed at a selected position in the nuclear reaction section by determining the position of the supply port of the source material and the irradiated position with the pulse laser light. Accordingly, the spaces necessary for the nuclear reaction section and for the radiation shielding system can be much smaller than those in the conventional apparatus and, in turn, the scale of the entire generating apparatus can be made compact. Further, since the radioisotope generating apparatus according to the present invention is compact, it can be readily used in a direct coupled state to the utilizing facilities, and the radioisotope generated in the nuclear reaction section can be quickly collected by the product nucleus collecting section to be utilized efficiently.

The term “vacuum” herein represents a degree of vacuum in which the desired nuclear reaction can take place with little influence of inhibition due to impurities except for the foregoing source material. Therefore, the vacuum is by no means limited, for example, to scientific high vacuums (1×10⁻⁶ to 1×10⁻² Pa), but it can also be either one of so-called ultra-high vacuums and extra-high vacuums.

Preferably, the radioisotope generating apparatus of the present invention further comprises a nuclear reaction monitor section for monitoring reaction product particles in the nuclear reaction section; and a nuclear reaction control section for controlling a supply condition of the source material in the source supply section, based on output of the nuclear reaction monitor section. This permits the nuclear reaction to be controlled more precisely, so that the radioisotope can be generated more efficiently.

The “reaction product particles” herein indicate all particles generated in the nuclear reaction in the nuclear reaction section and are properly selected from nuclei, protons, neutrons, electrons, positrons, photons, and so on.

### BRIEF DESCRIPTION OF THE DRAWINGS

FIG. 1 is a block diagram of a radioisotope generating apparatus according to an embodiment of the present invention.

FIG. 2 is a block diagram to show a specific configuration of the radioisotope generating apparatus of FIG. 1.

FIG. 3 is a block diagram to show another specific configuration of the radioisotope generating apparatus.

### DESCRIPTION OF THE PREFERRED EMBODIMENTS

Preferred embodiments of the present invention will be described below in detail with reference to the drawings. Throughout the drawings, identical or equivalent portions will be denoted by the same reference symbols.

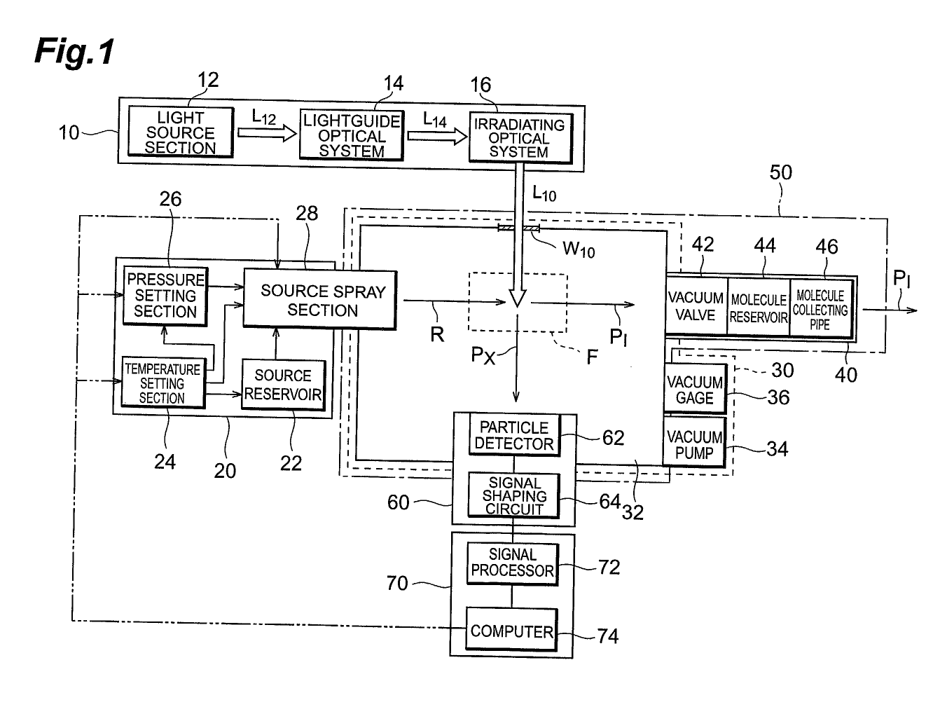

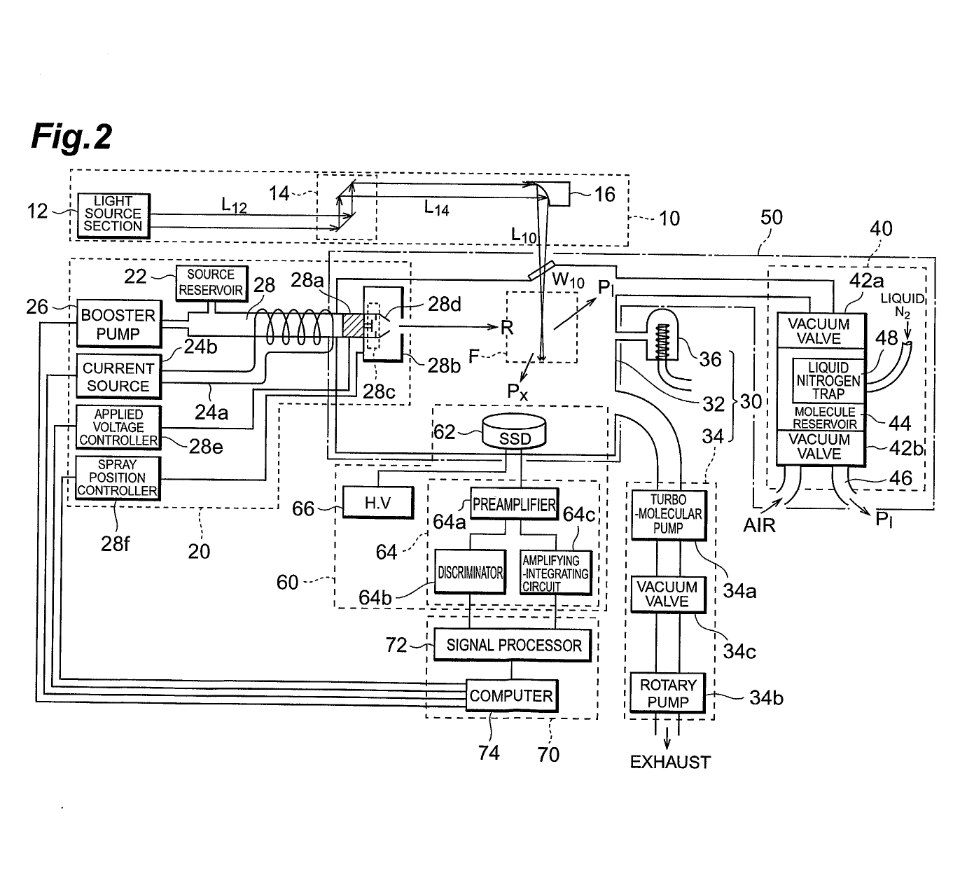

FIG. 1 shows the block structure of a preferred embodiment of the radioisotope generating apparatus according to the present invention. FIG. 2 shows a more specific configuration of the radioisotope generating apparatus of FIG. 1.

As shown in FIG. 1, the radioisotope generating apparatus of the present embodiment is comprised of a nuclear reaction section 30 the interior of which is retained in a vacuum; a source supply section 20 for supplying a source material R consisting of a nuclide necessary for generation of a radioisotope, to the nuclear reaction section 30; an optical system 10 for irradiating the source material R supplied into the nuclear reaction section 30 and thereby brought into a dispersed state, with pulse laser light, thereby inducing a nuclear reaction in the source material R to generate the radioisotope; a product nucleus collecting section 40 for collecting molecules P_{I} having nuclei of the radioisotope generated in the nuclear reaction section; a radiation shielding system 50 for preventing outside leakage of radiations generated in the nuclear reaction section 30; a nuclear reaction monitor section 60 for monitoring reaction product particles P_{X} in the nuclear reaction section 30; and a nuclear reaction control section 70 for controlling a supply condition of the source material R in the source supply section 20, based on output of the nuclear reaction monitor section 60.

Each of the above components will be detailed below on the basis of FIG. 1 showing the block structure and FIG. 2 showing the more specific configuration.

As shown in FIG. 1, the optical system 10 is comprised of a light source section 12 for emitting the pulse laser light L₁₂ of high peak power; a lightguide optical system 14 for guiding the output light L₁₂ from the light source section 12 to a desired position and in a desired orientation without degradation of optical characteristics thereof due to dispersion or the like to emit output light L₁₄; and an irradiating optical system 16 for amplifying optical intensity and density of the output light L₁₄ from the lightguide optical system 14 and emitting output light L₁₀ toward the interior of the nuclear reaction section 30. Since this output light L₁₀ is the pulse laser light of high peak power, the field of nuclear reaction is limited to only a small region irradiated with the output light L₁₀. Namely, thanks to the pulse laser light L₁₀ of high peak power, the reaction field of the desired nuclear reaction can be formed in the small region that is always spatially defined. This small region where the desired nuclear reaction occurs will be referred to hereinafter as “nucleus generating region F.”

The light source section 12 is constructed using a titanium-sapphire laser system to emit the pulse laser light L₁₂ of high peak power having the wavelength of 800 nm, the pulse width of 30 fs, and the energy per pulse of 200 mJ. The pulse laser light having such properties can be generated by known pulse amplification methods. This titanium-sapphire laser system can be constructed even in the table top size.

As shown in FIG. 2, the lightguide optical system 14 is comprised of reflecting optical elements such as plane reflectors, concave mirrors, off-axis parabolic reflectors, or the like which are fully resistant to the pulse laser light. By a combination of these reflecting optical elements, the optical system can propagate the output light L₁₂ from the light source section 12 without degradation of the optical characteristics thereof due to dispersion or the like. This is effective, particularly, in the case wherein the irradiating optical system 16 is located at a position where the output light L₁₂ from the light source section 12 cannot be directly guided to the irradiating optical system 16, because of the structure of the apparatus.

As shown in FIG. 2, the irradiating optical system 16 is also comprised of reflecting optical elements similar to the lightguide optical system 14. By a combination of these reflecting optical elements, the irradiating optical system 16 can implement convergence and the like of the output light L₁₄ from the lightguide optical system 14, thereby amplifying the optical intensity and density of the output light L₁₄ from the lightguide optical system 14. If the influence of dispersion and others is negligible, the light may be converged by transmitting optical elements such as lenses and the like.

It is also possible to incorporate part or the whole of the optical system 10 into the nuclear reaction section 30 as occasion demands. This configuration is effective in the case wherein the output light L₁₀ from the optical system 10 has the peak power insufficient to be supplied as stable output light in air and in the case wherein the output light L₁₀ is converged within a very short distance to decrease the size of the converged spot, thereby yielding a high power density.

As shown in FIG. 1, the source supply section 20 is comprised of a source reservoir 22 in which a fixed amount of the source material R is reserved; a source spray section 28 for supplying the source material R from the source reservoir 22 by spraying it into the nuclear reaction section 30; a temperature setting section 24 for setting the temperature of the source material R sprayed from the source spray section 28; and a pressure setting section 26 for setting the pressure of the source material R sprayed from the source spray section 28, and has such structure as to hermetically seal in the source completely except for an outlet of the source spray section 28. By these, the source material R is set at the temperature and pressure suitable for induction of the desired nuclear reaction and is accurately sprayed into the nucleus generating region F being the small reaction field formed in the nuclear reaction section 30.

The source material R is properly selected and used from materials consisting of a nuclide necessary for generation of a desired radioisotope. Particularly, for obtaining the radioisotopes used as medical tracers, it is effective to use water as a source material. Reasons for it are that natural water fully contains ¹⁶O and ¹ H necessary for synthesis of ¹³N and that there is no need for extra purification. A stainless steel vessel or the like is used as the source reservoir 22 for reserving the source material R and the internal wall surface of the vessel is properly treated by a surface treatment such as a teflon coating or the like in consideration of the chemical properties of the source material R employed and an operation temperature range. This source reservoir 22 is directly coupled to the source spray section 28 by a stainless steel pipe.

As shown in FIG. 2, the temperature setting section 24 is comprised of a heater 24a employing a nichrome wire or the like, and a current source 24b for supplying an electric current to the heater 24a to generate heat. This heater 24a is wound, particularly, over the source spray section 28 and generates heat under the supply of the electric current from the current source 24b to retain the source spray section 28 at a desired temperature. By this structure, the source material R in the source spray section 28 is set at the desired temperature and is sprayed as a gas jet from the outlet. The heater is also wound around such portions as the source reservoir 22 and the pressure setting section 26 except for meters to control the temperature in order to keep the temperature of the source material R uniform as occasion demands. Particularly, where the source material R before sprayed needs to be completely vaporized, or the like, the source supply section 20 is totally heated so as to prevent the source material R from condensing in the temperature setting section 24.

The pressure setting section 26 is provided with a booster pump, and this booster pump is directly coupled to the source spray section 28 by a stainless steel pipe. This allows the source material R to be sprayed under a desired pressure from the outlet of the source spray section 28. Since the interior of the source supply section 20 is hermetically sealed in, the booster pump does not always have to be provided if the sufficient pressurization effect is achieved by expansion of the source material R heated by the temperature setting section 24.

As shown in FIG. 2, the source spray section 28 is provided with a gas valve 28a having the diameter of about 2 mm in the outlet part and is arranged to project the outlet part into the nuclear reaction section 30. This gas valve 28a is equipped with a position adjusting mechanism 28b capable of moving the spray position of the source material R. For controlling this position adjusting mechanism 28b, a spray position controller 28f is provided outside the nuclear reaction section 30 and is electrically connected to the position adjusting mechanism 28b. The outlet port at the distal end of the gas valve 28a is equipped with electromagnetic shutter 28c and gas jet nozzle 28d. This electromagnetic shutter 28c is constructed to open and close by an applied voltage from the outside. For this purpose, an applied voltage controller 28e for controlling the applied voltage to the electromagnetic shutter 28c is disposed outside the nuclear reaction section 30 and electrically connected to the gas valve 28a.

By this position adjusting mechanism 28b, the source material R is able to be readily introduced into the nucleus generating region F where the nuclear reaction occurs efficiently in the nuclear reaction section 30. Since the provision of the electromagnetic shutter 28c permits the source material R to be sprayed in agreement with the irradiation timing of the output light L₁₀ from the optical system 10 guided into the nuclear reaction section 30, it is feasible to bring about the nuclear reaction efficiently and reduce the load on a vacuum pump 34 provided in order to keep the nuclear reaction section 30 in a vacuum.

Concerning the source supply section 20, it is also possible to incorporate part or the whole of the source supply section 20, as well as the source spray section 28, into the nuclear reaction section 30.

As shown in FIG. 1, the nuclear reaction section 30 is comprised of a vacuum chamber 32, a vacuum pump 34 for keeping the interior of the vacuum chamber 32 in a high vacuum, and a vacuum gage 36. These permit the reaction field of nuclear reaction to be retained under the high vacuum condition.

The vacuum chamber 32 is a stainless steel chamber adapted for high vacuums. The vacuum chamber 32 is provided with an optical window W₁₀ of quartz coated with antireflection coatings on the both surfaces thereof for incidence of the output light L₁₀ from the optical means 10. This quartz optical window W₁₀ has a sufficient transmittance suitable for the wavelength of the output light L₁₀ from the optical means 10 and is also fully resistant to the intensity of the output light L₁₀. The quartz optical window W₁₀ is provided with the antireflection coatings on the both surfaces and is arranged at the Brewster angle to polarization of the output light L₁₀. By this arrangement, the output light L₁₀ is converged more efficiently in the vacuum chamber 32.

This quartz optical window W₁₀ is set at a determined position in the vacuum chamber 32, whereby the irradiated region with the output light L₁₀ from the optical means 10 is almost fixed in the vacuum chamber 32. Further, the outlet part of the source spray section 28 in the source supply section 20 is arranged to be inserted in the vacuum chamber 32, so that the spray position of the source material R can be adjusted so as to agree with the irradiated region with the output light L₁₀ from the optical means 10. By this arrangement, the nucleus generating region F where the nuclear reaction occurs efficiently is formed in the small region that is always defined in the vacuum chamber 32. This permits the size of the vacuum chamber 32 to be set small within the range where the meters set inside are not damaged by the nuclear reaction, and, in turn, the scale of the entire reactor can be largely decreased as compared with the conventional reactors.

As shown in FIG. 2, the vacuum pump 34 is comprised of a turbo-molecular pump 34a having the exhaust rate of 600 l/s, and a rotary pump 34b. The turbo-molecular pump 34a is directly coupled to the vacuum chamber 32 by a pipe adapted for high vacuums and the rotary pump 34b is directly coupled similarly through a vacuum valve 34c to the exhaust side of the turbo-molecular pump 34a. By this vacuum pump 34, the interior of the vacuum chamber can also be maintained in the high vacuum of about 1×10⁻³ Pa even during the spraying of the source material R.

The vacuum gage 36 is an ionization gage. This can directly measure the degree of vacuum inside the vacuum chamber 32. This vacuum gage 36 is located at a position where it can directly measure the degree of vacuum inside the vacuum chamber 32 and where it is not directly hit by the source material R sprayed from the source spray section 28. In the present embodiment the vacuum gage is set in a peripheral area of an intake port of the vacuum pump 34 in the vacuum chamber 32.

As shown in FIG. 2, the product nucleus collecting section 40 is comprised of a vacuum valve 42a directly coupled to the vacuum chamber 32; a molecule reservoir 44 for collecting and temporarily storing molecules P_{I} having the nuclei of the radioisotope generated in the vacuum chamber 32 via the vacuum valve 42a; a vacuum valve 42b provided on the exit side of the molecule reservoir 44; and a molecule collecting pipe 46 for guiding the molecules P_{I} having the nuclei of the radioisotope, stored in the molecule reservoir 44, to the external utilizing facilities. This product nucleus collecting section 40 can be disconnected independently from the nuclear reaction section 30 by the vacuum valve 42a and can also be disconnected independently from the radioisotope utilizing facilities by the vacuum valve 42b. This product nucleus collecting section 40 directly guides the molecules P_{I} of the radioisotope collected in the molecule reservoir 44, through the molecule collecting pipe 46 to equipment installed outside to make them available in various applications.

The vacuum valves 42a and 42b are not limited to specific valves as long as they are adaptable for high vacuums; for example, they can be ultra-high vacuum valves such as bellows valves, clapper valves, gate valves, and so on for radiant light and accelerators.

The molecule reservoir 44 herein is a liquid nitrogen trap consisting of a copper vessel or the like. This is constructed to keep liquid nitrogen in the copper vessel with a large external surface area to form a large low-temperature surface, and by this trap, the molecules P_{I} having the nuclei of the radioisotope to be collected come to adhere onto the copper surface to be collected. For example, when ¹³N is produced from the source material R of water, nitric oxide, ammonia, and nitrogen molecules adhere onto the copper surface. Since the boiling points of nitric oxide and ammonia are high, they can be adequately collected by the trap. On the other hand, the nitrogen molecules cannot be collected at so high collection efficiency because of the use of the liquid nitrogen trap, but it is not so serious in this case, because the probability of the produced nitrogen nuclei existing as nitrogen molecules is low. Since the produced nuclei are bound to the source material, the product nucleus atoms, other suspended molecules, or the like to be collected as stable gas molecules, a collecting means is selected according to a purpose. Therefore, the method of trapping the molecules P_{I} having the nuclei of the radioisotope does not have to be limited to the above method, but an electromagnetic method may also be employed, for example.

The molecule collecting pipe 46 is a stainless steel pipe adapted for high vacuums. This molecule collecting pipe is properly treated by a treatment such as a teflon coating or the like on the internal wall part according to the necessity depending upon the chemical properties of the collected molecules P_{I}.

For selectively collecting only the necessary molecules P_{I} having the nuclei of the radioisotope, the apparatus may also be preliminarily provided with a particle discriminator (not shown) capable of discriminating physical and chemical properties such as the energy, mass, charge amount, magnetic moment, momentum, etc. of particles, before the vacuum valve 42a. A discriminator utilizing a grid electrode, a quadrupole discriminating magnetic field, TOF, or the like is used as the particle discriminator.

The radiation shielding system 50 is constructed of a lead plate 5 cm thick. By covering the entire shielded object by the lead plate, the emission amount of radiations generated by the nuclear reaction can be reduced to a level safe for human bodies or environments. The shielded objects by the radiation shielding system 50 are normally the nuclear reaction section 30 and the product nucleus collecting section 40 with large radiation emission amounts. The other components of the apparatus, such as the optical system 10, the source supply section 20, and so on, may also be properly shielded by the radiation shielding system 50 if the structure of the apparatus necessitates. For example, where radiant nuclides produced are not adequately collected, the gas discharged from the vacuum pump 30 to the outside of the apparatus can also be an object to be shielded. This radiation shielding system 50 is suitably provided with an optical window for guiding the output light L₁₀ from the optical means 10 into the vacuum chamber 32 and an inlet port for supply of the source from the source supply section 20.

Since the radioisotope generating apparatus of the present embodiment permits the desired nuclear reaction to take place within the small nucleus generating region F positioned in the vacuum chamber 32, as described previously, the scale of the vacuum chamber 32 can be largely decreased as compared with the conventional radioisotope generators. Accordingly, the scale of the shielding system 50 can also be largely decreased. For this reason, the structure of the shielding system 50 can also be readily made simple and high in sealability against radiations. Since the nuclear reaction section 30 and the radiation shielding system 50 can be constructed in the small scale as described above, the radioisotope generating apparatus can be constructed in compact size and with high safety, and facilitates on-site installation even if the installation space is somewhat small at the facilities utilizing the produced radioisotope. For example, the apparatus can be readily installed in a limited space at medical treatment facilities of small scale. Since the apparatus can also be installed on-site at large-scale radioisotope utilizing facilities that are presently located only at limited places because of difficulties in acquisition of the necessary radioisotope sources, it also becomes feasible to locate such large-scale radioisotope utilizing facilities at desired installation sites.

Since the radioisotope generating apparatus is compact, the construction cost thereof is lower than that of the conventional apparatus. Further, since the apparatus can be used by switching it on and off at necessary occasions, it can be operated according to schedules of users and without needless power consumption. In addition, since the radioisotope generating apparatus is able to produce the radioisotope easier than the conventional apparatus, it can be momentum to promote the development of drugs and others by making use of abundant radioisotopes as medical tracers.

From these advantages, the entire radioisotope generating apparatus according to the present invention can be constructed in compact structure by setting the scale of the nuclear reaction section 30 and the radiation shielding system 50 to the minimum and constructing the apparatus using the compact laser unit of the table top size as described previously, and the price thereof can be approximately a hundred million yen including installation cost. In contrast to it, the conventional cyclotron accelerators include a large reactor, because the isotope generating region cannot be fixed in a small region. Further, since the accelerating mechanism itself generates numerous radiations, the whole of a room including the conventional apparatus must be shielded by a thick shielding plate. For this reason, even a compact reactor has the size of approximately 3 mφ (bottom)×2.5 m (height) and the entire room must be shielded by the lead plate 1.5 m thick for shielding against radiations. Further, the conventional apparatus needs to operate with consumption of large power of several hundred kW and necessitates a room for power distribution, and therefore at least about five hundred million yen are necessary for installation thereof. In addition, the conventional cyclotron accelerators consume needless power, because they are continuously operated.

In addition to the above-described structure, it is effective to provide the radioisotope generating apparatus of the present embodiment with the nuclear reaction monitor section 60 and the nuclear reaction control section 70 from viewpoints described below, for more efficient advance of the desired nuclear reaction. The pressure setting and temperature setting in the source supply section 20 as described above determine the spray speed of particles of the source material R sprayed from the source spray section 28, and also determine the size, degree of dispersion, and concentration of the particles. For example, it is known that gas sprayed under high pressure into vacuum (gas jet) forms clusters each consisting of about hundred thousand molecules because of the sudden cooling effect. When the size of such molecule clusters in the nucleus generating region F is not more than the Rayleigh length of the pulse laser light L₁₀ radiated, they can efficiently receive the energy of the pulse laser light L₁₀. Accordingly, for inducing efficient nuclear reaction, it is necessary for particles of optimal cluster size to exist in appropriate concentration and degree of dispersion in the nucleus generating region F. For this reason, it is important to precisely control the pressure and temperature of the source material R and the spray position of the source material. Further, it is also necessary to radiate the pulse laser light L₁₀ at good timing against the particles of the source material R existing under such appropriate conditions in the nucleus generating region F, and it is thus important to precisely control the spray timing of the source material R.

From these viewpoints, the nuclear reaction monitor section 60 is comprised of a particle detector 62 for detecting the reaction product particles P_{X} generated in the vacuum chamber 32, converting the detection result into an electric signal, and outputting the electric signal; and a signal shaping circuit 64 for shaping the electric signal from the particle detector 62 into a signal easy to process. Since types and kinetic energies of reaction product particles P_{X} generated by a nuclear reaction are peculiar to the nuclear reaction having occurred, the advance status of the nuclear reaction in the vacuum chamber 32 can be monitored by using the reaction product particles P_{X} as a probe.

The particle detector 62 is properly selected according to a type of reaction product particles P_{X} to be monitored. The probe particles are normally selected from relatively light nuclei except for the objective nuclide, protons, neutrons, electrons, positrons, or photons among the reaction product particles P_{X}. The reason is that lighter particles have greater kinetic energy and this facilitates identification of particles and measurement of their energy. Since the life of the reaction product particles P_{X} is short in air or in other media, the particle detector 62 is mounted in the vacuum chamber 32.

Particularly, when α particles generated by the nuclear reaction are detected, a silicon semiconductor detector (SSD) is used as the particle detector 62. In this case, a voltage supply 66 for applying a voltage to the SSD is disposed outside the vacuum chamber 32.

As long as the reaction product particles P_{X} being the probe are limited to only charged particles, a common particle detector 62 can be used for the detection thereof. However, when neutrons or photons need to be monitored in addition, a plurality of detectors suitable for respective detections might be necessitated.

The signal shaping circuit 64 is disposed outside the vacuum chamber 32. This signal shaping circuit 64 has the function of accepting the electric signal from the particle detector 62 and converting it into an electric signal (electric signal for trigger) based on information concerning the time of incidence of probe particles P_{X} into the particle detector 62 and an electric signal based on information concerning the total amount of charge generated in the particle detector 62, in order to identify the probe particles P_{X} incident to the particle detector 62 and measure their energy. For this reason, as shown in FIG. 2, the signal shaping circuit 64 is comprised of a preamplifier 64a for amplifying the weak electric signal from the particle detector 62, separating the signal into the electric signal for trigger and the electric signal for information of energy, and outputting them; a discriminator 64b for accepting the electric signal for trigger and outputting a digital pulse signal based on the time of incidence of the probe particles P_{X} into the particle detector 62; and an integrating circuit 64c for accepting the electric signal for information of energy and outputting an electric pulse signal based on the total amount of charge generated in the particle detector 62. This integrating circuit is provided with an amplifier for further amplifying the electric signal from the preamplifier, in order to facilitate the monitoring of the total amount of charge generated in the particle detector 62, from peak values of the electric pulse signal output. This enables the identification of the reaction product particles P_{X} and permits desired reaction product particles P_{X} to be selectively monitored as probe molecules even in situations where a plurality of nuclear reactions are expected to occur and in situations where a plurality of radioisotope nuclei are generated simultaneously.

When specific reaction product particles P_{X} are selected as probe particles, the apparatus may also be provided with a discriminator (not shown) for discriminating the physical and chemical properties such as the energy, mass, charge amount, magnetic moment, momentum, etc. of particles, before the particle detector 62. This discriminator is one selected from those utilizing the grid electrode, the quadrupole discriminating magnetic field, TOF, and so on.

The nuclear reaction control section 70 is comprised of a signal processor 72 for processing the electric signals from the signal shaping circuit 62 to identify the particles incident to the particle detector and determine the energy of the particles; and a computer 74 for controlling the spray conditions of the source material R in the source supply section 20, based on the data from the signal processor 72. This enables precise control according to the advance status of the nuclear reaction occurring in the vacuum chamber 32.

The signal processor 72 is composed of a logic circuit (not shown) and an A/D converter (not shown) for digitizing peak values of pulses. This signal processor 72 has the function of receiving the electric signals from the signal shaping circuit 64 to identify the reaction product particles P_{X} incident to the particle detector 62 and determine the energy of the particles P_{X}, and displaying these information in real time. By reference to this display by the signal processor 72, it becomes feasible to obtain knowledge about the nuclear reaction occurring in the vacuum chamber 32 and its efficiency and make reference thereto for adjustment for optimizing the nuclear reaction.

The computer 74 is configured to read in the data concerning the identification of the reaction product particles P_{X} incident to the particle detector 62 and the energy thereof from the signal processor 72 and, based on the read data, determine the type of the nuclear reaction occurring and the yield of the radioisotope P_{I} produced by the nuclear reaction, from the energy value of the reaction product particles P_{X} and the relative time difference between the spraying of the source and the laser irradiation. Further, the computer 74 sends respective electric signals to the spray position controller 28f of the source spray section 28 in the source supply section 20, to the applied voltage controller 28e, to the current source 24b of the temperature setting section 24, and to the booster pump of the pressure setting section 26 so as to induce the desired nuclear reaction at the optimal Ad radioisotope yield, based on these information (cf. FIG. 2). This makes it feasible to precisely control the spray position, spray timing, and the spray speed of the source material R in accordance with the incidence timing of the pulse laser light L₁₀ into the nucleus producing region F, and the degree of dispersion of molecule cluster sizes etc. and the concentration of the particles of the source material R arriving at the nucleus generating region.

The nuclear reaction monitor section 60 and the nuclear reaction control section 70 can be omitted where the nucleus production efficiency is rarely affected by the laser incidence and the source spray conditions, where the conditions of the apparatus are preliminarily optimized, or where it is possible to extract the objective nuclei for utilization and determine an amount thereof.

The operation of the radioisotope generating apparatus shown in FIG. 1 and FIG. 2 will be described below.

First, the interior of the vacuum chamber 32 is evacuated to the vacuum degree of about 1×10⁻³ Pa in order to induce the desired nuclear reaction under conditions without influence of impurities. The vacuum valve 34c is first opened to evacuate the chamber by only the rotary pump 34b while observing the vacuum degree inside the vacuum chamber 32 on the ionization gage 36. When the vacuum degree tops out, the turbo-molecular pump is then activated while the rotary pump 34b is kept operating, until the degree of vacuum inside the vacuum chamber 32 reaches about 1×10⁻³ Pa.

Then the optical system 10, source supply section 20, nuclear reaction monitor section 60, and nuclear reaction control section 70 are actuated to induce the nuclear reaction to generate the radioisotope. While the reflecting optical elements located in the lightguide optical system 14 adequately suppress the dispersion, it guides the pulse laser light L₁₂ of high peak power emitted from the light source section 12, and delivers it as the output light L₁₄ in the predetermined orientation to the installation position of the irradiating optical system 16. This output light L₁₄ is converged by the off-axis parabolic mirror of the irradiating optical system 16 and is further emitted as the output light L₁₀ with amplified intensity and density. Then this output light L₁₀ travels through the quartz optical window W₁₀ mounted on the vacuum chamber 32 to enter the vacuum chamber 32. The quartz optical window W₁₀ is coated with the antireflection coatings on the both surfaces and is arranged at the Brewster angle to the polarization of the output light L₁₀. Therefore, the output light L₁₀ incident into the vacuum chamber 32 is efficiently converged in the small fixed region inside the vacuum chamber 32. For this reason, the position of the nucleus generating region F where the desired nuclear reaction occurs efficiently is also defined in the small fixed region inside the vacuum chamber 32.

When there arises a need for further increasing the converging efficiency of the output light L₁₀, the following process is carried out before the evacuation of the interior of the vacuum chamber 32; a white sheet is placed near a point of convergence, the energy of the pulse laser light is adequately reduced by an ND filter or the like, and the angle of the off-axis parabolic mirror is adjusted while observing a beam cross section of the pulse laser light of reduced energy by a CCD camera or the like.

On the other hand, the source material R is sprayed toward the nucleus generating region F from the gas valve 28a of the source supply section 20. At this time, in order to reduce the load on the vacuum pump 34 as much as possible as described previously, the open/close timing of the electromagnetic shutter 28c is controlled so as to implement the spraying of the source material R in synchronism with the arrival time of the output light L₁₀ at the nucleus generating region F. Since a time of nanosecond order is actually necessary for bringing the sprayed gas into a steady state, the source material R is sprayed toward the nucleus generating region F at the timing earlier by a period of that time than the output light L₁₀ arrives. The spraying timing of this source material R is controlled by the computer 74 through the applied voltage controller 28e by monitoring the product amount of the nuclear reaction product P_{X} in the nuclear reaction monitor section 60, as described previously. Likewise, since the position adjusting mechanism 28b is also controlled by the computer 74 through the position controller 28f by monitoring the product amount of the nuclear reaction product P_{X}, the spraying position of the source material R is also controlled at the optimal position for guiding the source material to the nucleus generating region F. Further, similarly, the output of the booster pump 26 and the output of the current source 24b are also controlled by the computer 74 so that the source material R has the suitable cluster size, degree of dispersion, and concentration in the nucleus generating region F.

When the pulse laser light L₁₀ of high peak power is converged on the source material R existing under the optimal conditions in the nucleus generating region F in this way, clusters of the source material R efficiently receive the energy from the laser light, because the size of the clusters is not more than about the Rayleigh length of the laser light. Therefore, many electrons in the clusters are torn off, so as to cause great positive charging. As a consequence, there occurs Coulomb explosion and the like and nuclei constituting the clusters come to have huge kinetic energy to be scattered to the surroundings at considerably high speeds. This results in letting some of these nuclei approach each other up to considerably near distances. Further, some of these nuclei tunnel the Coulomb barrier to approach each other up to within the reach of nuclear force. Once the nuclei approach each other to within the reach of nuclear force, a nuclear reaction takes place. Namely, two approaching nuclei pull each other to create a fused nucleus. Since this fused nucleus is very unstable, it quickly fissions at a time or in a cascade manner into some nuclei and other particles. This results in producing nuclides different from the nucleus constituting the source material R.

The reaction product particles P_{X} produced in this way all are theoretically usable and the desired radioisotope P_{I} is collected out of the particles. A suitable one is selected out of the radioisotope P_{I} and the reaction product particles and is used as probe particles P_{X} for monitor.

When the source material R is water, ¹³N, which can be used as a medical tracer in PET and the like, can be gained according to the reaction below.

¹⁶O+¹H(p)→¹³N+4He(α)

The nitrogen atoms thus produced couple with oxygen atoms or oxygen molecules, hydrogen atoms or hydrogen molecules, or other nitrogen atoms floating in the vicinity to form nitrogen oxide, ammonia, or nitrogen molecules. The α particles produced simultaneously fly fast to be trapped by the side wall of the vacuum chamber 32, or float as helium gas.

By modifying the aforementioned various conditions of the source material R and the source supply section 20, it becomes feasible to implement other isotope production reactions. For example, the following reactions other than the above reaction occur as reactions to produce nuclides used in PET. These reactions all can be implemented by spraying the source material containing the left-side atoms in the reaction formulae, under appropriate conditions.

¹⁴N+¹H(p)→¹¹C+4He (α)

¹²C+²H(d)→¹³N+n

¹⁴N+²H(d)→¹⁵O+n

¹⁸O+¹H(p)→¹⁸F+n

²⁰Ne+²H(d)→¹⁸F+4He (α)

During occurrence of these nuclear reactions, the radiation shielding copper plate also prevents the leakage of radiations to the outside of the apparatus. Particularly, in the radioisotope generating apparatus of the present embodiment, the scale of the radiation shielding system 50 can be much smaller than in the conventional radioisotope generating apparatus, as described previously, and thus the radiation shielding facilities are of simple structure with high sealability against radiations and high safety, e.g., because of the advantage of capability of decreasing welded portions of copper plates.

In the next place, the radioisotope P_{I} produced according to either of these nuclear reactions is collected. During progress of the nuclear reaction the vacuum valve 42a is kept open to guide the radioisotope P_{I} to the molecule reservoir 44 and reserve it there. When a necessary amount of the radioisotope P_{I} is reserved, the vacuum valve 42a is closed to return the molecule reservoir 44 to ordinary pressure, and the radioisotope P_{I} is collected. At this time, the vacuum valve 42a is first closed so as to disconnect the molecule reservoir 44 from the vacuum system 30. Then the vacuum valve 42b is opened to open the pipe connecting the molecule reservoir 44 to the molecule collecting pipe 46. At this time the molecule collecting pipe 46 is set at ordinary pressure, so that the molecule reservoir 44 is exposed to the ordinary pressure upon the opening of the valve. Here the liquid nitrogen in the liquid nitrogen trap 48 is removed whereby during the stage of temperature rise in the trap the molecules P_{I} becoming over the boiling point thereof are consecutively vaporized to be guided through the molecule collecting pipe 46 directly to the utilizing facilities installed on-site.

In the product nucleus collecting section 40 the vacuum valve 42a is closed where the radioisotope P_{I} is directly used in the vacuum chamber 32.

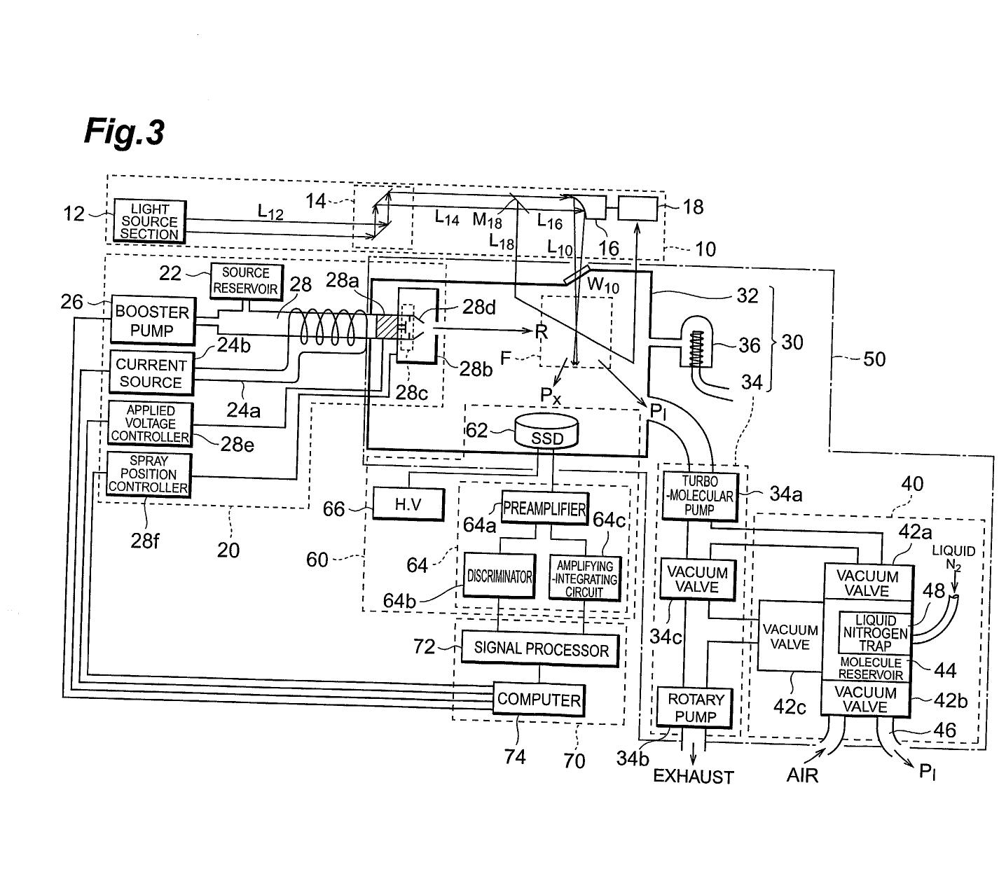

FIG. 3 shows another specific configuration of the radioisotope generating apparatus. This is different in two points below from the configuration of FIG. 1 and FIG. 2.

Firstly, the optical means 10 is provided with an irradiated light control section 18 for monitoring the irradiation state in the nucleus generating region F with the output light L₁₀ emitted from the irradiating optical system 16 and controlling the irradiation conditions of the irradiating optical system 18; a beam splitter M₁₈ for splitting the output light L₁₄ from the lightguide optical system 14 and outputting probe light L₁₈ for the irradiated light control section 18 and output light L₁₆ for induction of nuclear reaction. For example, a method of monitoring the convergence state of the output light L₁₀ can be selected from FTOP (Japanese Patent Application No. H11-150073), the Schlieren method, the optical pulse scattering method, the optical pulse up chirp and blue shift method, and so on. By such methods using light as a probe, the nuclear reaction can be monitored in situ at the same time as a start of reaction. For carrying out these, however, there arises a need for injecting the probe light L₁₈ normally to the traveling direction of the nucleus generating laser light and, for this reason, the probe light is produced by branching part of the pulse laser light L₁₂ for generation of nucleus emitted from the light source section 12. For implementing it, the vacuum chamber 32 is provided with a reflecting optical element (not shown) and an optical window (not shown) for injecting the probe light L₁₈. This allows the desired nuclear reaction to be precisely controlled from the side of the excitation output light L₁₀.

The beam splitter M₁₈ is one sufficiently resistant to the pulse laser light L₁₄ as the reflecting optical elements used in the lightguide optical system 14 are. This beam splitter M₁₈ splits the output light L₁₄ from the lightguide optical system 14 to inject part thereof as probe light L₁₈ into the vacuum chamber 32, and the probe light L₁₈ is made incident from the normal direction to the excitation light L₁₀ in the nuclear reaction region F and then emerges from the vacuum chamber 32. The irradiated light control section 18 receives this probe light L₁₈, performs a process to convert this optical signal into an electric signal by a photodiode or the like, and controls the irradiating optical system so as to optimize the convergence state of the excitation light L₁₀ in the nuclear reaction region F.

Secondly, the product nucleus collecting section 40 is attached to the back of the exhaust port of the turbo-molecular pump 34a through a branch connected midway to the pipe connecting the turbo-molecular pump 34a to the rotary pump 34b in the vacuum pump 34. This configuration can implement such piping that on the occasion of collecting the molecules P_{I} having the nuclei of the desired radioisotope the gas containing the molecules P_{I}, discharged from the turbo-molecular pump 34a, always passes the molecule reservoir 44 and then reaches the rotary pump 34b, which enables more efficient collection of the molecules P_{I} having the nuclei of the radioisotope.

The operation of the radioisotope generating apparatus shown in FIG. 3 is basically the same as that of the radioisotope generating apparatus shown in FIG. 1 and FIG. 2, and, therefore, the operations of the constituent sections added to the radioisotope generating apparatus of FIG. 1 will be described below.

For optimizing the irradiation conditions including the convergence state of the output light L₁₀ from the optical system 10 to irradiate the nucleus generating region F, part of the nuclear reaction inducing light L₁₄ emitted from the lightguide optical system 14 is branched by the beam splitter M₁₈ disposed in the optical system 10 to be outputted as the probe light L₁₈ toward the nucleus generating region F in the vacuum chamber 32. Then this probe light L₁₈ passing through the nucleus generating region F and emerging therefrom is guided into the irradiated light control section 18, and the irradiated light control section 18 determines the optimum irradiation conditions of the nuclear reaction inducing light L₁₀, changes the irradiation conditions of the irradiating optical system, based on the data, monitors the actual nuclear reaction in situ from the side of the inducing light, and finely adjusts the conditions so as to perform the nuclear reaction at maximum efficiency.

For collecting the molecules reserved in the molecule reservoir 44, the vacuum valve 34c is first opened to open the pipe directly connecting the turbo-molecular pump 34a to the rotary pump 34b. Then, in order to disconnect the molecule reservoir 44 from the vacuum system 30, the vacuum valves 42a, 42c are closed to close the pipes connecting the molecule reservoir 44 to the vacuum pump 34. Then the vacuum valve 42b is opened to open the pipe connecting the molecule reservoir 44 to the molecule collecting pipe 46. At this time, since the molecule collecting pipe 46 is set at the ordinary pressure, the molecule reservoir 44 is exposed to the ordinary pressure upon the opening of the valve. Here the liquid nitrogen in the liquid nitrogen trap 48 is removed whereby during the stage of temperature rise in the trap the molecules P_{I} becoming over the boiling point thereof are consecutively vaporized to be guided through the molecule collecting pipe 46 to the utilizing facilities installed on-site. In order to increase temporal efficiency of collection, another pipe different from the pipe used for the collection of molecules is guided to the molecule reservoir 44 and air at an appropriate temperature is forcibly supplied through the pipe thereto. For again carrying out the collection of product molecules P_{I}, the pipes are returned to the original arrangement and liquid nitrogen is introduced to the liquid nitrogen trap 48.

The preferred embodiments of the present invention were described above in detail, but it is noted that the present invention is by no means intended to be limited to the above embodiments. For example, the source material does not have to be selected from only materials that form molecule clusters in vacuum by the gas jet, but may also be selected from materials that form molecule clusters in vacuum by a liquid jet. Further, it is also possible to use organic solids, such as granulated sugar, and other solid targets that form no molecule cluster in vacuum. The foregoing radioisotope generating apparatus was described as to the generation of radioisotopes, but the radioisotope generating apparatus according to the present invention can also generate stable isotopes.

The radioisotope generating apparatus according to the present invention can also be adapted for directly utilizing lightweight particles other than the radioisotope generated during the generation of nuclei. For example, the apparatus may also be modified to selectively induce a nuclear reaction to generate positrons with low energy and guide the positrons thus generated, directly to a positron microscope installed outside, thereby constituting a compact positron microscope system as a whole.

What is claimed is:

1. A radioisotope generating apparatus for generating a radioisotope, comprising:
a nuclear reaction section an interior of which is retained in a vacuum;
a source supply section for supplying a source material consisting of a nuclide necessary for generation of the radioisotope, to said nuclear reaction section;
an optical system for irradiating said source material supplied into said nuclear reaction section and thereby brought into a dispersed state, with pulse laser light, thereby inducing a nuclear reaction in said source material to generate the radioisotope;
a product nucleus collecting section for collecting a molecule having a nucleus of the radioisotope generated in said nuclear reaction section; and
a radiation shielding system for preventing outside leakage of radiations generated in said nuclear reaction section.

2. The radioisotope generating apparatus according to claim 1, further comprising:
a nuclear reaction monitor section for monitoring reaction product particles in said nuclear reaction section; and
a nuclear reaction control section for controlling a supply condition of said source material in said source supply section, based on output of said nuclear reaction monitor section.
